(19) United States
(12) Patent Application Publication
(10) Pub. No.: US 2006/0181563 A1
(43) Pub. Date: Aug. 17, 2006

(54) Image recording method and image recording apparatus

(76) Inventor: Yukihiro Niekawa, Tokyo (JP)

Correspondence Address: CANTOR COLBURN, LLP, 55 GRIFFIN ROAD SOUTH, BLOOMFIELD, CT, 06002, US

(21) Appl. No.: 11/203,036

(22) Filed: Aug. 11, 2005

(30) Foreign Application Priority Data
Aug. 18, 2004 (JP) JP2004-238239

(51) Int. Cl. B41J 29/393

(52) U.S. Cl. 347/19

(57) ABSTRACT

An image recording method comprises quantizing an image data, discharging a photocurable ink from a recording head onto a recording medium based on the image data quantized for forming recorded dots, irradiating light at the photocurable ink of the recorded dots for recording an image by curing and fixing, calculating an ink emission rate per a predetermined recording area based on the image data quantized, judging whether the ink emission rate not less than a predetermined value in the recording area, and thinning out the image data by using a thin-out pattern corresponding to the recording area so that the ink emission rate to be discharged onto the predetermined recording area is less than the predetermined value when the ink emission rate is judged to be not less than the predetermined value.

This application is based on Japanese Patent Application No. 2004-238239 filed on Aug. 18, 2004, in Japanese Patent Office, the entire content of which is hereby incorporated by reference.

### TECHNICAL FIELD

The present invention relates to an image recording method and an image recording apparatus, particularly to an image recording method and an image recording apparatus for fixing an image on a recording medium using photocurable ink.

### BACKGROUND

In recent years, the image recording method using photocurable ink has been used to record an image on a recording medium characterized by poor ink absorbing capacity. According to this method, photocurable ink containing a photo-initiator sensitive to a particular beam of light is emitted to reach a recording medium. Then a specific beam of light is applied thereto to cure and fix the ink on the recording medium. This procedure allows an image to be recorded on a recording medium made of polyvinyl chloride or PET (polyethylene terephthalate) having a poor ink absorbing capacity.

To minimize bleeding, discoloration and other failures on the recording medium and to achieve high-quality printing according to the aforementioned image recording method, the following art has been disclosed: Light irradiation range control means is synchronized with the operation of a cartridge so that light will not be applied to the maintenance unit. Thus, light is applied only to the ink that requires curing on the recording medium, and the ink outside this range is not cured (Patent Document 1).

In some cases, image quality is improved by an image recording method using the ink having a plurality of densities in the same color. This method improves the image quality in the low density range. If the density is increased, ink density will exceed 100%. This will result in an ink overflow, as is widely known.

To keep the amount of emitted ink below the permissible level in such an image recording method, a record master data conforming to the inputted image data and the characteristics of the recording medium is created to set the amount of ink to a specified level. Thus the amount of ink emission is forcibly created, thereby avoiding an ink overflow (Patent Document 2).

[Patent Document 1] Japanese Patent Publication Open to Public Inspection No. 2003-127347

[Patent Document 2] Japanese Patent Publication Open to Public Inspection No. 2003-80691

According to the image recording method based on photocurable ink, the ink having reached a recording medium rises in a convex form. In the so-called solid portion containing much ink, ink particles are linked in the main scanning direction, and the projections and depressions of ink overlap each other to produce uneven ink surfaces in a streaked form, as is widely known.

This is because the ink having risen on the recording medium characterized by ink absorbing capacity is cured in a convex form, with the result that projections and depressions are formed on the recording medium. In the main scanning direction, the timing of the nozzle emitting ink is accurate, and ink reaches the recording medium correctly at predetermined intervals. However, in the sub-scanning direction, while ink is emitted, feed operation is carried out by the conveyance apparatus where precision is inferior to that in the main scanning direction. Depending on the angular error of ink emission and an error in hitting the recording medium, a variation occurs in the precision of the position hit by the ink. Thus, the intervals of variation cause the projections and depressions of ink to overlap with each other, with the result that uneven ink surfaces in a streaked form are produced.

To reduce an overlap of the projections and depressions of ink that is provided when photocurable ink is used and to reduce the uneven ink surfaces, the aforementioned method of ink overflow is applied. This method controls the overall amount of ink emission, and is not necessarily effective in reducing uneven ink surfaces in a streaked form resulting from the overlap of ink projections and depressions specific to the photocurable ink.

### SUMMARY

An embodiment of the invention may provide an image recording method and an image recording apparatus capable of reducing the uneven ink surfaces in a streaked form resulting from the overlap of ink projections and depressions on a recording medium printed, using a photocurable ink.

An embodiment of the present invention may provide an image recording method comprising: quantizing an image data, discharging a photocurable ink from a recording head onto a recording medium based on the image data quantized for forming recorded dots, irradiating light at the photocurable ink of the recorded dots for recording an image by curing and fixing, calculating an ink emission rate per a predetermined recording area based on the image data quantized, judging whether the ink emission rate not less than a predetermined value in the recording area, and thinning out the image data by using a thin-out pattern corresponding to the recording area so that the ink emission rate to be discharged onto the predetermined recording area is less than the predetermined value when the ink emission rate is judged to be not less than the predetermined value by the judging.

And, the embodiment may provide the emission calculation when the photocurable inks of a plurality of colors are used, calculates the aforementioned emission of ink separately for each of the inks of a plurality of colors.

And, the embodiment provides the thin-out pattern is a pattern which thins out the recorded dots of a higher ink emission rate.

And, the embodiment provides the thinned out dots in the thin-out pattern are arranged at random.

And, the embodiment provides the thinned out dots in the thin-out pattern are arranged in rows in the main scanning direction.

And, the embodiment provides the thinned out dots in the thin-out pattern are arranged in rows in the sub-scanning direction.

And, the embodiment provides the thin-out pattern is a pattern which thins out the recorded dots of a higher ink emission rate corresponding to the recording medium or the kind of photocurable ink.

And, the embodiment may provide the recording method comprising detecting whether the margin or thin line portion of the image data in the recording area, thinning-out the recording area other than the margin or thin line portion based on the result of the detection.

And, an another embodiment provides an image recording apparatus comprises a quantization processor to quantize an image data, a recording head to form a recorded dots by discharging a photocurable ink based on the image data quantized, a light irradiation apparatus for applying beams to the recorded dots, an ink emission rate calculation section to calculate an ink emission rate per a predetermined recording area based on the image data quantized, a judgment section to judge whether the ink emission rate not less than a predetermined value in the recording area, a thin-out section to thin-out the image data by a thin-out pattern corresponding to the recording area so that the ink emission rate to be discharged onto the predetermined recording area is less than the predetermined value when the ink emission rate is judged to be not less than the predetermined value by the judgment section, and a recording section to record an image by curing and fixing the irradiated photocurable ink of the record dots.

And, the embodiment provides the light irradiation apparatus emits ultraviolet rays.

And, the embodiment provides the photocurable ink is cationic polymerized ink.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a schematic configuration diagram representing an image recording apparatus as a first embodiment;

FIG. 2 is a block diagram showing a schematic control configuration of an image recording apparatus as a first embodiment;

FIG. 3 is a diagram showing the relationship between the unit area block and pixel of the present embodiment;

FIG. 4 is a diagram showing an example of the pixel thin-out pattern of the present embodiment;

FIG. 5 is a diagram showing another example of the pixel thin-out pattern of the present embodiment;

FIG. 6 is a block diagram showing a schematic control configuration of an image recording apparatus as a second embodiment;

FIG. 7 is a diagram showing an example of the thin line of the present embodiment; and

FIG. 8 is a diagram showing an example applying a thin-out pattern to the thin line of the present embodiment.

### DESCRIPTION OF THE PREFERRED EMBODIMENT

The following describes the recording apparatus as an embodiment of the present invention, which is not restricted to the examples shown in Figures.

### Embodiment 1

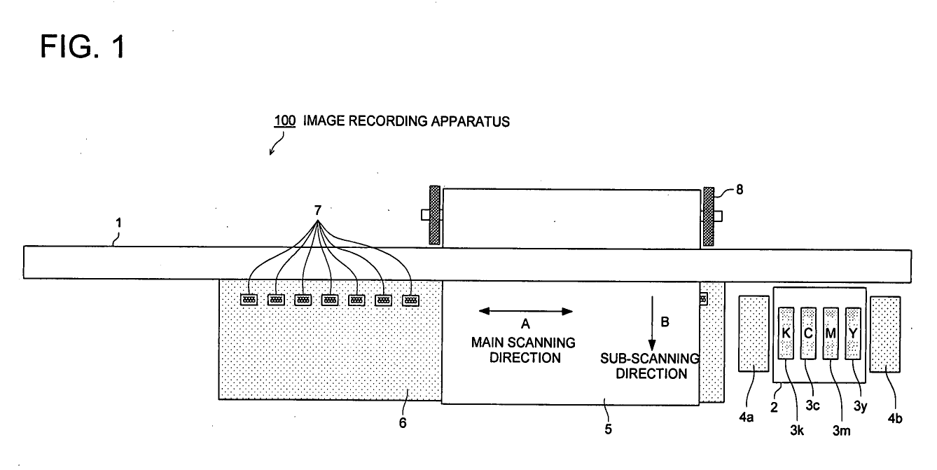

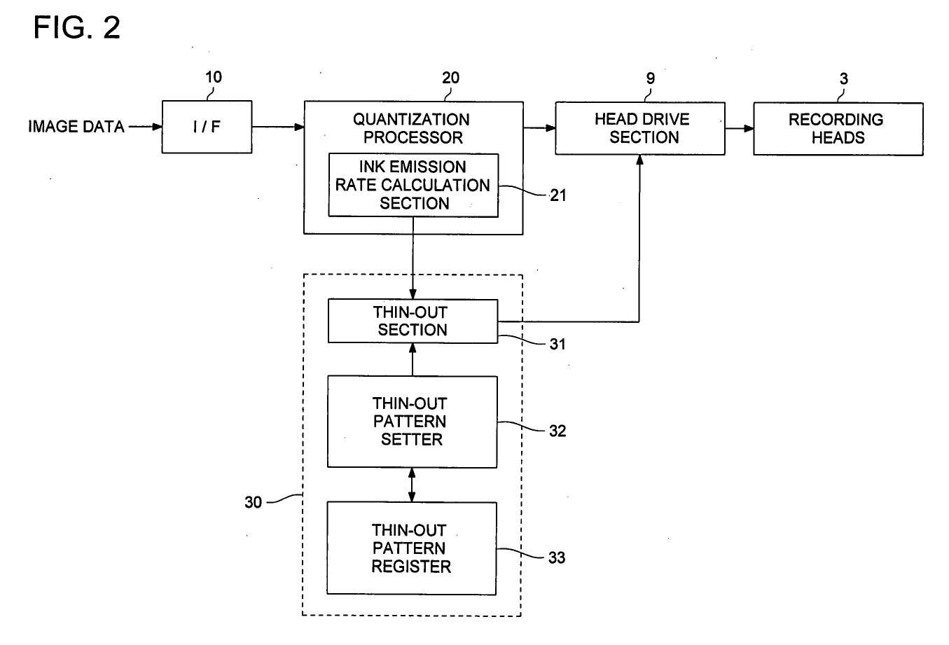

Referring to FIGS. 1 and 2, the following describes the image recording apparatus as a first embodiment of the present invention: FIG. 1 is a schematic configuration diagram representing an image recording apparatus 100. FIG. 2 is a block diagram showing a schematic control configuration of an image recording apparatus 100.

As shown in FIG. 1, the image recording apparatus 100 is equipped with a rod-like main scanning guide member 1. A carriage 2 is supported by the main scanning guide member 1, and is driven by a carriage motor (not illustrated). The carriage 2 is freely movable reciprocally in the main scanning direction A, i.e., in the longitudinal direction along the main scanning guide member 1. The direction orthogonal to the main scanning direction A is defined as a sub-scanning direction B.

The carriage 2 is provided with four recording heads 3y, 3m, 3c and 3k driven by a head drive section 9 (not illustrated) in FIG. 1. On each surface of the recording heads 3y, 3m, 3c and 3k opposed to the recording surface of a recording medium 5, a plurality of nozzles (not illustrated) for emitting ink are arranged in the sub-scanning direction B. Inks of process colors—yellow (Y), magenta (M), cyan (C) and black (K)—are emitted to the recording surface of the recording medium 5 from the nozzle, based on the image data inputted from the outside.

Two ultraviolet ray irradiation apparatuses 4a and 4b are mounted on both ends of the carriage 2 in the main scanning direction A, wherein the ultraviolet ray irradiation apparatuses 4a and 4b allows ultraviolet rays to be applied to the recording surface of the recording medium 5 through lighting of an irradiation source, thereby curing and fixing the ink having reached the recording surface of the recording medium 5. A low-voltage mercury lamp, high-voltage mercury lamp, metal halide lamp, excimer lamp, hot-cathode tube, cold-cathode tube, ultraviolet laser or LED (Light-Emitting Diode) is used as an ultraviolet ray irradiation apparatus.

A flat platen 6 for supporting the recording medium 5 is provided in the area where recording is applied to the recording medium 5 within the range where the carriage 2 is movable. A conveyance roller 7 is provided upstream from the platen 6 in the sub-scanning direction B, the aforementioned conveyance roller 7 being driven by a conveyance motor (not illustrated) to convey the recording medium 5.

A recording medium winding master roll 8 wound with a long recording medium 5 is arranged rotatably upstream from the platen 6 supporting the non-recording surface of the recording medium 5 in the sub-scanning direction B. The length of recording medium winding master roll 8 can be adjusted to conform to the width of the recording medium 5.

The following describes the image recording apparatus 100 as an embodiment of the present invention, with reference to the block diagram representing the schematic control configuration of the image recording apparatus 100 given in FIG. 2:

In the image recording apparatus 100 having the configuration shown in FIG. 1, the recording heads 3y, 3m, 3c and 3k for printing on a recording medium based on the image data are connected with a head drive section 9, as shown in FIG. 2, so that drive control is provided by the head drive section 9. The head drive section 9 are connected with a quantization processor 20 for quantization of the input data having been inputted from outside; and a number-of-pixels control section 30 for calculating the amount of ink in a predetermined recording area, based on the image data subsequent to quantization and comparing the result with a predetermined value, thereby thinning out the recorded dots the recording area where the ink emission rate exceeds the predetermined value. The quantization processor 20 is connected with an I/F (interface) 10 for inputting the image data from the host computer connected to the outside, including a PC.

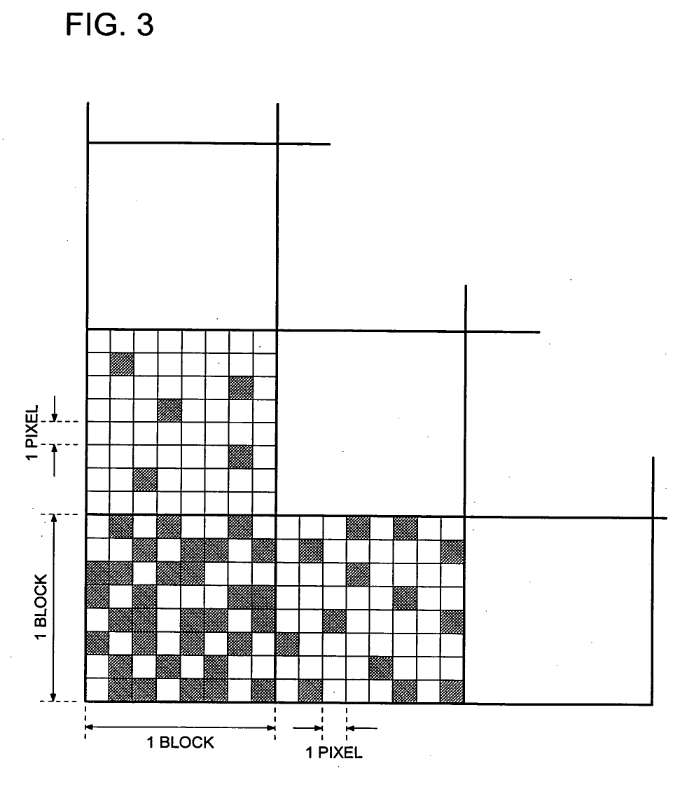

The quantization processor 20 comprises an ink emission calculation section 21, namely, an ink emission rate calculation means for calculating the emission rate of ink per recorded dot in units of blocks having a predetermined recording area, as shown in FIG. 3, and for comparing the result with a predetermined value. The predetermined value is expressed in terms of the percentage of the recording pixels in units of blocks or ink emission rate. The predetermined value is changes with the size of the block. For example, one side of a block is composed of eight pixels, as shown in FIG. 3, and the ink emission rate is 20 pl per pixel. Under this condition, 90% of the recording pixels are equivalent to the ink emission rate of 1152 pl. The number-of-pixels control section 30 comprises:

a thin-out section 31 for thinning out the recorded dots in the area where the ink emission rate per recorded dot has been determined to exceed the predetermined level;

a thin-out pattern setter 32 for selecting from the pattern register 33 the thin-out pattern for thinning out the recorded dots in response to the area where the ink emission rate exceeds the predetermined level, and setting the pattern in the thin-out section 31; and

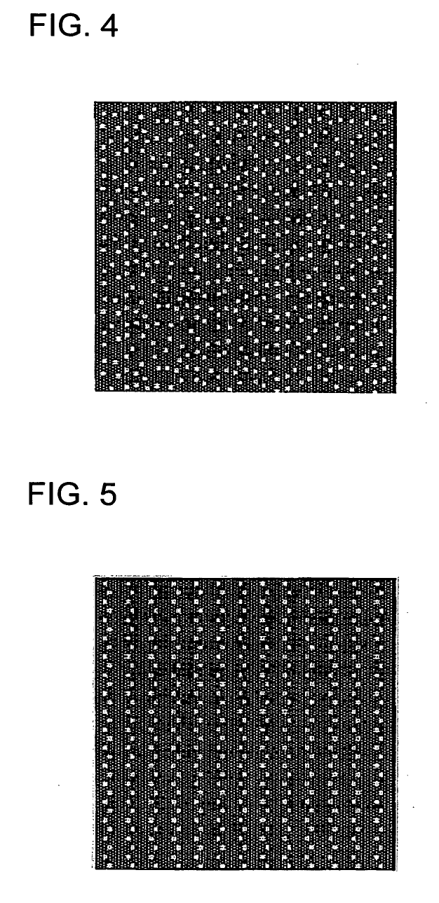

a pattern register 33, namely, a thin-out recording means where a plurality of thin-out patterns shown in FIGS. 4 and 5 are registered. FIG. 4 shows the pixel thin-out pattern for randomly thinning out the recorded dots in the recording area where the amount of ink exceeds a predetermined level. FIG. 5 shows another pixel thin-out pattern wherein the thinned out dots are arranged so that the recorded dots in the recording area where the amount of ink exceeds a predetermined level are thinned out in rows main scanning direction. The pattern register 33 can be configured to register the thin-out pattern wherein the thinned out dots are arranged so as to thin out the recorded dots in rows in the main scanning direction, the aforementioned recorded dots being located in the recording area where the amount of ink exceeds the predetermined value.

Image data is inputted into the head drive section 9 from the ink emission rate from the quantization processor 20 and number-of-pixels control section 30, the aforementioned image data being obtained by thinning out the ink emission rate to be below the predetermined value. This head drive section 9 drives the three-phase, based on the image data so as to emit process color inks of yellow (Y), magenta (M), cyan (C) and black (K) to the recording surface of the recording medium through each of the nozzles of the recording heads 3.

The following describes the image recording method of the present invention using the image recording apparatus 100 as a first embodiment of the present invention:

The image data inputted from the outside is inputted into the quantization processor 20 through the I/F 10 and is subjected to the process of quantization by the quantization processor 20. Based on the image data subsequent to quantization, ink emission rate for each of the recorded dots for each predetermined recording area shown in FIG. 3 is calculated by the ink emission calculation section 21, and the calculated ink emission rate is compared with the predetermined value wherein the percentage of the recording pixels is preset at 90%. The image data in the recording area where ink emission rate is higher than the predetermined value is outputted to the number-of-pixels control section 30, and the image data in the recording area where ink emission rate is lower than the predetermined value is outputted to the head drive section 9.

For the image data inputted into the number-of-pixels control section 30, the recorded dots in the recording area are thinned out by the thin-out section 31 according to the thin-out pattern corresponding to the recording area. A plurality of the thin-out patterns for thinning out the recorded dots in the recording area used in the thin-out section 31 are registered in advance in the pattern register 33. An appropriate pattern is selected and is set to the thin-out section 31 by the thin-out pattern setter 32.

The pattern register 33 incorporates a thin-out pattern for random thinning out of the recorded dots of the recording area as shown in FIG. 4; a thin-out pattern with the recorded dots arranged in such a way that the recorded dots in the recording area are thinned out in rows in the main scanning direction as shown in FIG. 5; and a thin-out pattern wherein the recorded dots in the recording area in the recording area are thinned out in rows in the sub-scanning direction (not illustrated). The thin-out pattern shown in FIG. 4 permits random thinning out of the recorded dots in the recording area with the ink emission rate exceeding the predetermined value. This provides the image data wherein the recorded dots are thinned out over the entire recording area where the ink emission rate exceeds the predetermined value. The image data having been thinned out is outputted to the head drive section 9 from the thin-out section 31. Use of the thin-out pattern shown in FIG. 5 allows recorded dots to be thinned out in rows in the recording area where the ink emission rate exceeds the predetermined value. This provides the image data with the recorded dots thinned out in the recording area where the ink emission rate exceeds the predetermined value. Thus, the image data having been thinned out is outputted to the head drive section 9 from the thin-out section 31.

Four recording heads 3y, 3m, 3c and 3k are driven according to the image data outputted to the head drive section 9 from the quantization processor 20 and number-of-pixels control section 30. Based on the image data, ink is emitted to the recording surface of the recording medium 5 from each nozzle. Emission of ink is accompanied by the ultraviolet rays applied to the recording surface of the recording medium 5 from the ultraviolet ray irradiation apparatuses 4a and 4b. Then the ink emitted from the recording heads 3y, 3m, 3c and 3k is exposed to ultraviolet rays, upon arrival at the recording medium 5, and is cured immediately to be fixed on the recording surface of the recording medium 5.

While the carriage 2 is moving from left to right in FIG. 1, the ultraviolet ray irradiation apparatus 4a lights up. While the carriage 2 is moving from right to left in FIG. 1, the ultraviolet ray irradiation apparatus 4b lights up. To put it another way, ultraviolet ray irradiation apparatus 4a (or 4b) located downstream from the recording heads 3y, 3m, 3c and 3k in the traveling direction of the carriage 2 lights up to apply ultraviolet rays.

On the other end in the reciprocating motion of the carriage 2, the recording medium 5 is fed in the sub-scanning direction by the conveyance roller 7, with the non-recording surface supported by the platen 6, while the recording medium winding master roll 8 is rotating.

After that, the image recording apparatus 100 repeats the aforementioned operation, and the images based on the image data composed of a plurality of recorded dots of various process colors are sequentially recorded on the recording surface of the recording medium 5.

In the recording apparatus as the first embodiment described above, calculation is made to find out the recording area where the ink emission rate exceeds the predetermined value, the recorded dots are thinned out. This procedure keeps the ink emission rate at the predetermined value. This reduces overlap of the recorded dots and minimizes the overlap of cured inks on the recording medium using photocurable ink, whereby occurrence of uneven ink surfaces can be prevented.

### Embodiment 2

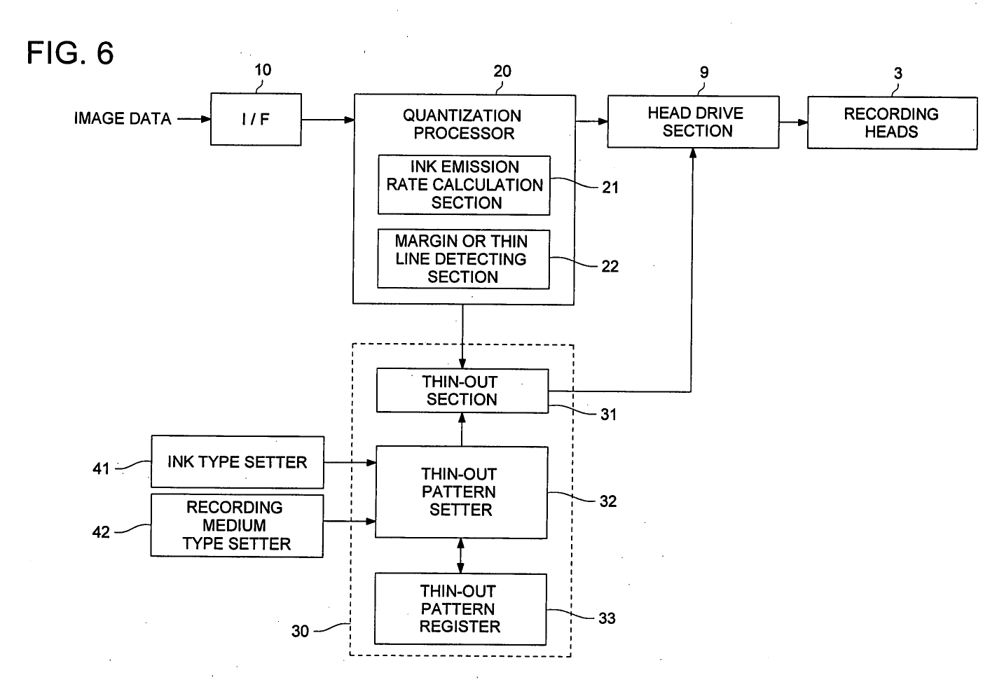

Referring to FIG. 6, the following describes the second embodiment of the image recording apparatus 100 of the present invention: In the second embodiment, there is a difference in the configuration of the quantization processor 20 and number-of-pixels control section 30 (FIG. 2) from that of the first embodiment. Otherwise, the configuration is the same with that of the first embodiment (FIGS. 3 through 5). The second embodiment will be described mainly with reference to the quantization processor 20 and number-of-pixels control section 30. The same parts as those of the first embodiment will be assigned with the same reference numerals, and the description will be omitted to avoid duplication.

FIG. 6 is a block diagram showing a schematic control configuration of an image recording apparatus 100. As shown in FIG. 6, the image recording apparatus 100 comprises:

an I/F (interface) 10 for inputting the image data from the host computer connected to the outside including a PC;

a quantization processor 20 for quantization of the image data;

a number-of-pixels control section 30 for calculating the ink emission rate for a predetermined recording area, based on the image data subsequent to quantization; and comparing the result with a predetermined value, thereby thinning out the recorded dots in the recording area where the ink emission rate exceeds the predetermined value;

an ink type setter 41 for setting the type of ink on the number-of-pixels control section 30;

a recording medium type setter 42 for setting the recording medium type on the number-of-pixels control section 30; and

a head drive section 9 for driving recording heads 3y, 3m, 3c and 3k for printing on the recording medium, based on the image data subsequent to quantization.

As shown in FIG. 3, the quantization processor 20 comprises:

an ink emission rate calculation section 21 for calculating the emission rate of ink per recorded dot in units of blocks having a predetermined recording area, and comparing the result with the predetermined value; and

a margin or thin line detecting section 22 for checking if the recording area is a margin or thin line portion.

The number-of-pixels control section 30 comprises:

a thin-out section 31 for thinning out the recorded dots in the area where the ink emission rate per recording dot for each predetermined recording area is determined to exceed the predetermined value;

a thin-out pattern setter 32 for selecting from the pattern register 33 the thin-out pattern corresponding to the ink type or recording medium type inputted from the ink type setter 41 or recording medium type setter 42, and for setting the selected pattern on the thin-out section 31; and

a pattern register 33 for registering the thin-out pattern of a plurality of recorded dots shown in FIGS. 4 and 5.

The following describes the image recording method used in the image recording apparatus 100 as a second embodiment:

The image data inputted from the outside is inputted into the quantization processor 20 through the I/F 10 and is subjected to quantization. Based on the image data having been quantized, the ink emission rate calculation section 21 calculates the emission rate of ink per recorded dot in units of blocks having a predetermined recording area shown in FIG. 3. The margin or thin line detecting section 22 checks if the recording area is a margin or thin line portion. The calculated ink emission rate is compared with the preset predetermined value such as the percentage of the recording pixels being 90%. The image data in the recording area where the ink emission rate is lower than the predetermined value, and the recording area, where the ink emission rate exceeds the predetermined value, having been determined to be a margin or thin line portion, are outputted to the head drive section 9. The recording area, other than the aforementioned one, where the ink emission rate exceeds the predetermined value is outputted to the number-of-pixels control section 30.

The image data having been inputted to the number-of-pixels control section 30 is subjected to thinning out of the recorded dots in the recording area by the thin-out section 31, using the thin-out pattern corresponding to the predetermined recording area. After thinning out, the image data is outputted to the head drive section 9. A plurality of the thin-out patterns for thinning out the recorded dots, used by the thin-out section 31, are registered in the pattern register 33 in advance. An appropriate one is selected by the thin-out pattern setter 32 and the selected one is set on the thin-out section 31. The thin-out pattern setter 32 selects the optimum thin-out pattern best suited to the ink type or recording medium type inputted by the ink type setter 41 or recording medium type setter 42. The ink type setter 41 or recording medium type setter 42 can be installed, for example, on the operation panel, PC or ink tank to detect the ink type or recording medium type.

To show an example of a thin-out pattern, Table 1 shows the ink emission rate per unit area and the thinning out rate of the recorded dots when the recording medium is made of PET (polyethylene terephthalate), polyvinyl chloride/tarpaulin or YUPO coated paper. Since the dot diameter when ink has hit the recording medium varies according to the characteristics of the recording medium and ink such as viscosity, spread, and wettability, projections and depressions the ink produced by a combination of the recording medium and ink to be used are different. Accordingly, the ink emission rate and thin-out rate of the recorded dots are also different. When the recording medium is made of polyvinyl chloride/tarpaulin or YUPO coated paper, the ink having reached the recording medium is cured without the dot diameter being increased. This increases the ink emission rate per predetermined area, and the thin-out rate of the recorded dots, as well. Conversely, in the case of PET, the ink having been hit the recording medium is cured after the dot diameter has increased. This reduces the ink emission rate per predetermined area, and the thin-out rate of the recorded dots, as well.

TABLE 1

| | Ink emission rate | Thin-out rate |
|---|---|---|
| Recording medium | (ml/m²) | (%) |
| PET | 9.6 | 5 |
| Polyvinyl | 12.9 | 11 |
| chloride/tarpaulin | | |
| YUPO coated paper | 14.5 | 13 |

Table 1 shows the ink emission rate for each color and recorded dot thin-out rate. Basically, the same values are set for all colors, but adjustment for each color is also possible. Further, for the secondary color or higher, the total amount of ink emission can be controlled for all colors by the ink rate restriction method having been long practiced, such as the UCR method, and an embodiment of the present invention may be applied to the portion of highly packed recorded dots for each color, whereby processing of thinning out can be carried out.

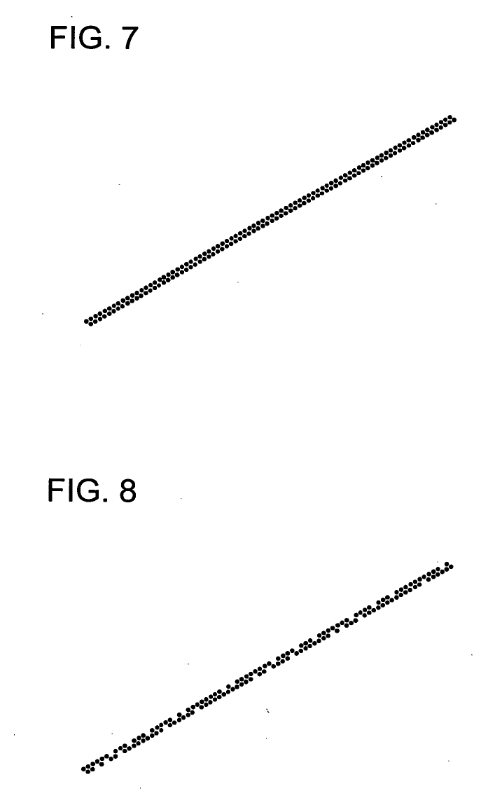

In the recording apparatus as a second embodiment described above, ink emission rate per recorded dot for a predetermined area is calculated and the result is compared with the predetermined value. In the recording area where the ink emission rate exceeds the predetermined value, the recorded dots are thinned out using the thin-out pattern best suited to the types of the ink and recording medium being used, so that the ink emission rate can be kept to the predetermined value. This procedure reduces the overlap of the recorded dots and the overlap of the cured ink that may occur to the recording medium when photocurable ink is used. Thus, occurrence of uneven ink surfaces can be reduced. Further, the pixel thin-out pattern is not applied to the recorded dots in the recording area of the margin or thin line section shown in FIG. 7. This ensures image recording free from a blur shown in FIG. 8.

According to the configuration according to the embodiment, ink emission rate per recorded dot for each predetermined recording area is calculated, based on the image data having been quantized. The result is compared with the predetermined value. The recorded dots in the recording area where the ink emission rate exceeds the predetermined value are thinned out using the thin-out pattern, thereby reducing the ink emission rate and recording the image. This arrangement reduces the overlap of the ink in the recorded dots and the differences in projections and depressions of ink. This method therefore minimizes the uneven ink surfaces resulting from overlap of the ink projections and depressions.

By thinning out the recorded dots in the recording area where the ink emission rate is higher, it is possible to thin out the recorded dots where uneven ink surfaces in a streaked form are likely to occur, and to reduce the overlap of the ink in recorded dots. This makes it possible to minimize the uneven ink surfaces resulting from overlap of the ink projections and depressions. Thus, this procedure provides an image recording method characterized by high image quality.

By thinning out the recorded dots in the recording area of higher ink emission rate using the thin-out pattern, it is possible to provide an image recording method for ensuring high image quality capable of minimizing uneven ink surfaces in a streaked form resulting from overlap of the ink projections and depressions.

The projections and depressions of ink on the recording medium differ according to the type of the recording medium, ink and a combination thereof. Accordingly, the overlap of ink in the recorded dots is reduced, using the thin-out pattern for thinning out the overlap of the ink in the recorded dots in response to the particular condition of each of the projections and depressions. This makes it possible to provide an image recording method, for recording a high quality image, capable of minimizing uneven ink surfaces resulting from overlap of the ink projections and depressions.

Evaluation is made to check whether or not the recording area is a margin or thin line portion. Based on the result, the recorded dots in the margin or thin line portion are not thinned out, even if the ink emission rate exceeds the predetermined value. This procedure prevents a blur from occurring on the image. This makes it possible to provide an image recording method, for recording a high quality image, capable of recording high-quality image faithful to the image data having been inputted.

The photocurable ink is cationic polymerized ink, which can be cured by application of ultraviolet rays. The cationic polymerized ink is more sensitive to ultraviolet rays than radical polymerized ink. The adverse effect on the polymerized system is smaller than that in the case of the radical polymerized ink. This makes it possible to reduce the level of illumination required to cure the ink emitted on the recording medium.

While the preferred embodiments of the present invention have been described using specific terms, such description is for illustrative purposes only, and it is to be understood that changes and variations may be made without departing from the spirit or scope of the appended claims.

1. An image recording method comprising:
quantizing an image data,
discharging a photocurable ink from a recording head onto a recording medium based on the image data quantized for forming recorded dots;
irradiating light at the photocurable ink of the recorded dots for recording an image by curing and fixing;
calculating an ink emission rate per a predetermined recording area based on the image data quantized;
judging whether the ink emission rate not less than a predetermined value in the recording area, and
thinning out the image data by using a thin-out pattern corresponding to the recording area so that the ink emission rate to be discharged onto the predetermined recording area is less than the predetermined value when the ink emission rate is judged to be not less than the predetermined value by the judging.

2. The image recording method of claim 1, wherein the emission calculation when the photocurable inks of a plurality of colors are used, calculates the aforementioned emission of ink separately for each of the inks of a plurality of colors.

3. The image recording method of claim 1, wherein the thin-out pattern is a pattern which thins out the recorded dots of a higher ink emission rate.

4. The image recording method of claim 1, wherein the thinned out dots in the thin-out pattern are arranged at random.

5. The image recording method of claim 1, wherein the thinned out dots in the thin-out pattern are arranged in rows in the main scanning direction.

6. The image recording method of claim 1, wherein the thinned out dots in the thin-out pattern are arranged in rows in the sub-scanning direction.

7. The image recording method of claim 1, wherein the thin-out pattern is a pattern which thins out the recorded dots of a higher ink emission rate corresponding to the recording medium or the kind of photocurable ink.

8. The image recording method of claim 1, further comprising:
detecting whether the margin or thin line portion of the image data in the recording area,
thinning-out the recording area other than the margin or thin line portion based on the result of the detection.

9. An image recording apparatus, comprising:
a quantization processor to quantize an image data;
a recording head to form a recorded dots by discharging a photocurable ink based on the image data quantized;
a light irradiation apparatus for applying beams to the recorded dots;
an ink emission rate calculation section to calculate an ink emission rate per a predetermined recording area based on the image data quantized;
a judgment section to judge whether the ink emission rate not less than a predetermined value in the recording area;
a thin-out section to thin-out the image data by a thin-out pattern corresponding to the recording area so that the ink emission rate to be discharged onto the predetermined recording area is less than the predetermined value when the ink emission rate is judged to be not less than the predetermined value by the judgment section; and
a recording section to record an image by curing and fixing the irradiated photocurable ink of the record dots.

10. The image recording apparatus of claim 9, wherein the ink emission rate calculation section to calculate the emission of ink separately for each of the inks of a plurality of colors when the photocurable inks of a plurality of colors are used.

11. The image recording apparatus of claim 9, wherein the thin-out pattern is a pattern which thins out the record dots of a higher ink emission rate.

12. The image recording apparatus of claim 9, wherein the thinned out dots in the thin-out pattern are arranged at random.

13. The image recording apparatus of claim 9, wherein the thinned out dots in the thin-out pattern are arranged in rows in the main scanning direction.

14. The image recording apparatus of claim 9, wherein the thinned out dots in the thin-out pattern are arranged in rows in the sub-scanning direction.

15. The image recording apparatus of claim 9, wherein the thin-out pattern is a pattern which thins out the record dots of a higher ink emission rate corresponding to the recording medium or the kind of photocurable ink.

16. The image recording apparatus of claim 9, further comprising:
a margin or thin line detecting section to detect whether the margin or thin line portion of the image data in the recording area,
a thin-out section to thin out the recording area other than the margin or thin line portion based on the result of the determination.

17. The image recording apparatus of claim 9, wherein the light irradiation apparatus emits ultraviolet rays.

18. The image recording apparatus of claim 9, wherein the photocurable ink is cationic polymerized ink.
